(19) United States
(12) Patent Application Publication
(10) Pub. No.: US 2004/0144017 A1
(43) Pub. Date: Jul. 29, 2004

(54) Fishing line sinker

(76) Inventors: Larry V. Glavinich, Banning, CA (US); Rodney Long, Banning, CA (US)

Correspondence Address: James E. Brunton, Esquire, Post Office 29000, Glendale, CA, 91209-9000, US

(21) Appl. No.: 10/746,394

(22) Filed: Dec. 24, 2003

Related U.S. Application Data
(60) Provisional application No. 60/437,086, filed on Dec. 27, 2002.

(51) Int. Cl. A01K 91/00

(52) U.S. Cl. 43/44.9

(57) ABSTRACT

A fishing line sinker and the method of matching same which is formed from a granulated metal such as tungsten, brass and steel and a castable binder such as glass and injection mold as plastic.

This is a Nonprovisional Application claiming the benefit of co-pending Provisional Application Serial No. 60/437,086 filed Dec. 27, 2002

### BACKGROUND OF THE INVENTION

1. Field of the Invention

The present invention relates generally to sinkers for use in fishing and the method of making same. More particularly, the invention concerns an improved sinker formed from granulated or powdered metals such as tungsten, brass and steel that are mixed with castable binding agents such as glass.

2. Background Information

Throughout history, man has struggled to advance the art of catching fish, for various and sundry reasons such as, but not restricted to hunger, sport and assurances that he is smarter than the fish.

Sinkers have been made from lead for many years, due to its density, and ease of manufacturing by casting it. In recent years, the concern of lead being toxic to wild life has resulted in other safer materials being used. Most of these metals are being machined into sinkers due to the complexity of trying to mold them at much higher temperatures than lead.

As will become apparent from the discussion which follows, the sinkers of the present invention use these safer metals such as tungsten, brass and steel, but use the metals in granulated form intermixed with other castable, yet less dense materials, such as glass. In these embodiments, the glass is used only as the binding agent for the powdered metals, such as tungsten, brass and steel.

### SUMMARY OF THE INVENTION

The present invention in the preferred embodiments are various embodiments of gear, said gear comprising sinkers with reduced tendency to snag. The preferred embodiment is a weight and slip wire combination with the weight, or sinker being formed from granulated metals mixed with castable binding agents such as molten glass.

### BRIEF DESCRIPTION OF THE DRAWINGS

FIGS. 1A, 1B and 1C illustrate various sinkers of the present invention.

### DESCRIPTION OF THE PREFERRED EMBODIMENTS

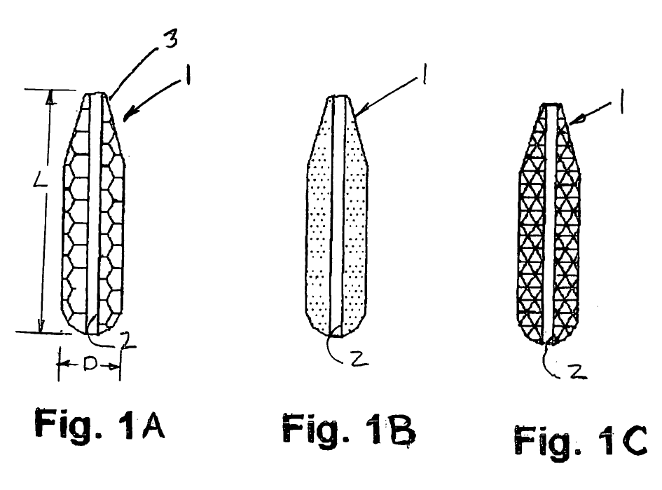

FIG. 1A illustrates one form of the sinker of the present invention namely, a sinker 1 which includes a slip wire clearance 2, a pointed end 3 and a length greater than five times the diameter D. Sinker 1 is formed, in a manner presently to be discussed, from a granulated tungsten and a castable glass binder.

FIG. 1B illustrates another form of sinker, which is at identical configuration to sinker 1, but is formed from a powdered brass and a injection moldable plastic binder.

FIG. 1C illustrates still another form of sinker of the same configuration as sinker 1. However, this later sinker is formed from granulated steel and a castable glass binder.

Sinkers have been made from lead for many years, due to its density, and ease of manufacturing by casting it. In recent years, due to the concern of lead being toxic to wild life, other materials are being used with most of the metals, being machined into sinkers due to the complexity of trying to mold them at much higher temperatures than lead. The new sinker materials of the present invention use these metals, but use them in granulated forms, mixing them with other castable yet less dense materials such as glass. In these embodiments, the glass is used only as the binding agent for the powdered metals, such as tungsten, brass and steel. These powdered metals are added to molten glass and then molded into the weight designs shown in the drawing. This greatly reduces the manufacturing cost of the weights and greatly increases their density when compared to glass alone. Plastic can also be used as the binder with the power metals being mixed into the plastic then injection molded.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A sinker comprising a mixture of a granulated metal and a castable binder.

2. The sinker as defined in claim 1 in which said binder is less dense than said metal.

3. The sinker as defined in claim 1 in which said granulated metal comprises tungsten.

4. The sinker as defined in claim 1 in which said granulated metal comprises brass.

5. The sinker as defined in claim 1 in which said granulated metal comprises steel.

6. The sinker as defined in claim 1 in which said binder comprises glass.

7. The sinker as defined in claim 1 in which said binder comprises injection moldable plastic.

8. A sinker comprising a mixture of powdered tungsten and glass.

9. A method of making a sinker comprising the steps of:
(a) mixing a granulated metal with a castable binder to form a mixture; and
(b) molding said mixture into a sinker having a slip wire clearance

10. The method as defined in claim 9 in which said granulated metal comprises tungsten.

11. The method as defined in claim 9 in which said granulated metal comprises brass.

12. The method as defined in claim 9 in which said granulated metal comprises steel.

13. The method as defined in claim 9 in which said castable binder comprises glass.

14. The method as defined in claim 9 in which said castable binder comprises plastic.
